(19) United States
(12) Patent Application Publication
(10) Pub. No.: US 2008/0292103 A1
(43) Pub. Date: Nov. 27, 2008

(54) METHOD AND APPARATUS FOR ENCRYPTING AND TRANSMITTING CONTENTS, AND METHOD AND APPARATUS FOR DECRYPTING ENCRYPTED CONTENTS

(75) Inventors: Choong-hoon LEE, Seoul (KR); Jun Yao, Suwon-si (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/942,072

(22) Filed: Nov. 19, 2007

(30) Foreign Application Priority Data
May 23, 2007 (KR) 10-2007-0050253

(51) Int. Cl. H04L 9/06

(52) U.S. Cl. 380/277

(57) ABSTRACT

Provided are a method and apparatus for encrypting and transmitting contents and decrypting the encrypted contents in order to improve security for authority of use of the contents in a contents used environment by installing various content protection software in a content device. The method of encrypting and transmitting the contents includes: receiving contents to be transmitted; encrypting the contents using a content key which is an encryption key according to the received contents; encrypting the content key using an external device key of an external device which is permitted to receive the encrypted contents to be used and a software key of a software program which is executed in the external device and permitted to decrypt the encrypted contents; and transmitting the encrypted contents and the encrypted content key to the external device. Therefore, security for authority of use of the contents, and more particularly, security for the content key are improved so that illegal distribution of the contents can be prevented.

### CROSS-REFERENCE TO RELATED PATENT APPLICATION

This application claims the benefit of Korean Patent Application No. 10-2007-0050253, filed on May 23, 2007, in the Korean Intellectual Property Office, the disclosure of which is incorporated herein in its entirety by reference.

### BACKGROUND OF THE INVENTION

1. Field of the Invention

The present invention relates to a method and apparatus for encrypting contents and transmitting the encrypted contents, and a method and apparatus for receiving and decrypting the encrypted contents, and more particularly, to a method and apparatus for encrypting and decrypting contents using a device key and a software key, in which various content protection software is installed in a content device so that security such as authority of use of contents is improved in an environment using contents.

2. Description of the Related Art

Due to widespread illegal copying of digital contents, various technologies for protecting content have been studied and developed. These technologies include Conditional Access System (CAS) for broadcasting contents protection, Digital Rights Management (DRM) for determining whether to use the contents according to authority of use of contents, and Content Scrambling System (CSS), Content Protection for Recordable Media (CPRM), and Advanced Access Content System (AACS) for protection of storage media.

Such content protection technologies use an encryption technology, and allow content use only by users or devices which have the right to use content in an appropriate way.

Most conventional content devices have their own specific content protection systems initially. In the case of these specific content protection systems, since the types of usable content are initially determined, users are restricted in using the content and selecting a service freely.

In other words, when contents are used in a specific device, contents in which DRM, that is not supported by the device, is applied cannot be used and contents that have been used in the device cannot be moved to another device that supports DRM, to be used. For example, contents in which a DRM solution manufactured by A cannot be used in a device in which a DRM solution manufactured by B is realized. Accordingly, such a predetermined content protection system limits the types of content which can be used in a device, thereby inconveniencing a user.

Such inconvenience increases when networking of content devices is accelerated. In an environment where a broadcasting service through the Internet is provided as in Internet TV (Internet Protocol Television (IPTV)) and also various services are provided through wire/wireless network in other content devices, if a particular content protection technology such as a specific DRM is implemented in a specific device, users are more restricted in using the services.

One method of overcoming this problem is to provide a content protection system in the form of software or firmware so that the content protection system can be installed in the device dynamically. That is, in order for a user to use desired contents, the content protection system applied to the corresponding contents is freely installed in a user's device in a software form so that the user can use various contents regardless of the type of the content protection system.

Meanwhile, most content protection systems such as DRM, CAS, and CSS that is a DVD content protection system protect the contents based on encryption. The content protection system encrypts the contents to distribute or sell to a user and allows only a trusted user to access a content key which can decode the contents, thereby protecting the contents.

Here, in general, data is encrypted using a secret key or a public key of another party and is transmitted. However, in the case of multimedia data, since the amount of such data is large, encrypting the contents for each user by allocating different keys to each user is inefficient because a large amount of content is encrypted with each of the different keys at separate times. Thus, in most cases, the content protection system uses a two-step encryption method in which identical contents are encrypted using a single content key and the content key is encrypted using a user's key possessed by each user.

The user's key may be a key included in various devices using contents such as a digital TV, a set top box, an MP3 player, a portable video player, a DVD player, and a Blu-ray player, or a software key included in content playing software.

In the case of various content protection systems, the content key is encrypted using the key in the content devices so as to control the contents to be used in a specific content device. That is, the contents are encrypted using the content key and are distributed and the content key is encrypted using the device key and is distributed. Thus, the content device receives the encrypted contents and the content key so that the content key is firstly decrypted using the device key and then the contents are decrypted using the decrypted content key.

In addition, in a software execution environment such as a PC, the content playing software functions as the content device, decrypts the content key using a key included in software, and decrypts the contents using the decrypted content key.

However, in an environment in which various content protection software is executed in the content device, when the content protection software possesses a key and the content key is encrypted using the key of the content protection software so as to be transmitted, if the software is copied to another device, the contents can be used in the other device.

On the other hand, when the content device possesses the key and the content key is encrypted using the device key so as to be transmitted, in other software which can be executed in the content device, the content key may be exposed to other unauthorized software.

### SUMMARY OF THE INVENTION

The present invention provides a method and apparatus for encrypting/transmitting and decrypting contents using a device key and a software key in a content device environment in which various content protection software is executed and thus various formats of content can be used, in order to improve security of a content key.

According to an aspect of the present invention, there is provided a method of encrypting and transmitting contents, including: encrypting contents to be transmitted using a content key which is an encryption key according to the received contents; encrypting the content key using an external device key of an external device which is permitted to receive the encrypted contents to be used and a software key of a software program which is executed in the external device and permitted to decrypt the encrypted contents; and transmitting the encrypted contents and the encrypted content key to the external device.

The encrypting the content key may include encrypting the content key using the external device key and then encrypting the encrypted result using the software key.

The encrypting the content key may include encrypting the content key using the software key and then encrypting the encrypted result using the external device key.

The external device key and the software key may comprise a secret key or a public key.

According to another aspect of the present invention, there is provided a method of decrypting encrypted contents, including: receiving encrypted contents to be played and an encrypted content key according to the received encrypted contents; decrypting the encrypted content key using a device key of a device which receives the encrypted contents and the a software key of a software program which is permitted to decrypt the encrypted contents; and decrypting the encrypted contents using the decrypted content key.

The decrypting the encrypted content key may include decrypting the encrypted content key using the device key and then decrypting the decrypted result using the software key.

The decrypting the encrypted content key may include decrypting the encrypted content key using the software key and then decrypting the decrypted result using the device key.

The device key and the software key that are used for decrypting the encrypted content key may include a secret key or a private key.

According to another aspect of the present invention, there is provided an apparatus for encrypting and transmitting contents, including: an input unit which receives contents to be transmitted; a first encryption unit which encrypts the contents using a content key which is an encryption key according to the contents received by the input unit; a second encryption unit which encrypts the content key using an external device key of an external device which is permitted to receive the encrypted contents to be used and a software key of a software program which is executed in the external device and permitted to decrypt the encrypted contents; and a transmitting unit which transmits the encrypted contents and the encrypted content key to the external device.

The second encryption unit may further include a device encryption unit which encrypts the content key using the external device key and a software encryption unit which encrypts the content key encrypted in the device encryption unit using the software key.

The second encryption unit may further include a software encryption unit which encrypts the content key using the software key and a device encryption unit which encrypts the content key encrypted in the software encryption unit using the external device key.

The external device key and the software key in the second encryption unit may include a secret key or a public key.

According to another aspect of the present invention, there is provided an apparatus for decrypting encrypted contents, including: a receiving unit which receives encrypted contents to be played and an encrypted content key according to the received encrypted contents; a first decryption unit which decrypts the encrypted content key using a device key of a device which receives the encrypted contents and the encrypted content key and a software key of a software program which is permitted to decrypt the encrypted contents; and a second decryption unit which decrypts the encrypted contents using the content key decrypted in the first decryption unit.

The first decryption unit may further include a software decryption unit which decrypts the encrypted content key using the software key and a device decryption unit which decrypts the content key decrypted in the software decryption unit using the device key.

The first decryption unit may further include a device decryption unit which decrypts the encrypted content key using the device key and a software decryption unit which decrypts the content key decrypted in the device decryption unit using the software key.

The device key and the software key in the first decryption unit may include a secret key or a private key.

According to another aspect of the present invention, there is provided a computer readable recording medium having embodied thereon a computer program for executing the method described above.

According to another aspect of the present invention, there is provided a content playing device comprising the apparatus described above.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of encrypting and transmitting contents according to an exemplary embodiment of the present invention;

FIG. 2 is a flowchart illustrating a method of encrypting and transmitting contents in more detail according to another exemplary embodiment of the present invention;

FIG. 3 is a flowchart illustrating a method of decrypting contents according to an exemplary embodiment of the present invention;

FIG. 4 is a flowchart illustrating a method of decrypting contents in more detail according to another exemplary embodiment of the present invention;

FIG. 5 is a functional block diagram of an apparatus for encrypting and transmitting contents according to an exemplary embodiment of the present invention;

FIG. 6 is a functional block diagram of an encryption unit of a content key in an apparatus for encrypting and transmitting contents according to an exemplary embodiment of the present invention;

FIG. 7 is a functional block diagram of an apparatus for decrypting contents according to an exemplary embodiment of the present invention; and

FIG. 8 is a diagram for explaining an operation of an apparatus for decrypting contents, according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

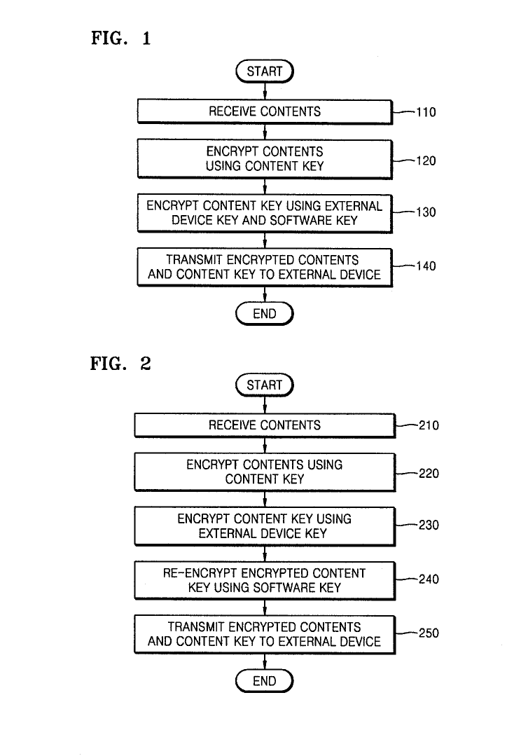

FIG. 1 is a flowchart illustrating a method of encrypting and transmitting contents according to an embodiment of the present invention.

Referring to FIG. 1, the method of encrypting and transmitting contents according to the current embodiment of the present invention includes receiving the contents, encrypting the contents using a content key that is an encryption key according to the received contents, encrypting the content key using a key of an external device which is permitted to receive and use the encrypted contents and a software key of a software program which is permitted to decrypt the encrypted contents that are executed in the external device and are received, and transmitting the encrypted contents and the content key to the external device in operations 110, 120, 130, and 140, respectively.

More specifically, the contents are received in operation 110. That is, content data to which a content protection system is applied is received and then the content data is encrypted and transmitted in the next operation.

In operation 120, the received contents are encrypted. Here, it is assumed that an encryption key used is a content key Kc according to the contents C and identical contents have identical content keys. As described above, since encrypting a large amount of contents using different user keys is inefficient, one amount of content is encrypted using one content key. In addition, a content key according to each amount of content can be obtained using an identifier id which classifies the contents and each content is encrypted using the content key.

In operation 130, the content key Kc is encrypted using the external device key and the software key. That is, in encrypting the content key Kc, instead of the content C itself, both the external device key and software key are used. Here, the external device is referred to a device which is previously permitted to receive the transmitted contents and to use the contents and software is referred to software which is permitted to decrypt the received contents from among various content protection software executed in the device. That is, the content key is encrypted using both the external device key and the software key. Accordingly, a content usable device and software can be determined in an encryption stage so that other devices and other software in the device can be prevented from accessing the contents, thereby increasing security to use the contents.

As described above, in operation 140, the encrypted contents and the encrypted content key are transmitted to the external device.

FIG. 2 is a flowchart illustrating a method of encrypting and transmitting contents in more detail according to another embodiment of the present invention. The method of FIG. 2 is similar to that of FIG. 1; however, encryption operations 230 and 240 in the method of FIG. 2 are described in more detail.

Referring to FIG. 2, the content key Kc is encrypted by sequentially using the external device key and software key in operations 230 and 240. That is, in encrypting the content key, encryption is performed using the external device key and then re-encryption is performed using the software key based on the result of the encryption using the external device key, thereby obtaining a final encrypted content key which can be expressed as E[Kc]. However, priorities of each operation are the same, so thus encryption using the software key can be performed first and then encryption using the external device key can be performed.

In order to easily understand the encryption process of the content key illustrated in FIG. 2, FIG. 6 can be referred to. FIG. 6 is a functional block diagram of an encryption unit of a content key in an apparatus for encrypting and transmitting contents according to an embodiment of the present invention. Referring to FIG. 6, the content key is encrypted in a separate process from a process of encrypting the contents using the content key. In FIG. 6, a second encryption unit 530 which encrypts the content key may further include internal encryption units such as a device encryption unit 531 and a software encryption unit 532. The device encryption unit 531 firstly encrypts the content key using the external device key and the encrypted result is transmitted to the software encryption unit 532. The software encryption unit 532 secondly encrypts the encrypted result transmitted from the device encryption unit 531 again using the software key of a software program which is permitted to decrypt the contents. As described above, the order of the encryption operation can be changed. In addition, the external device key and software key can comprise a secret key when a symmetric cryptographic technique is applied, or the external device key and software key can be a public key when an asymmetric cryptographic technique is applied.

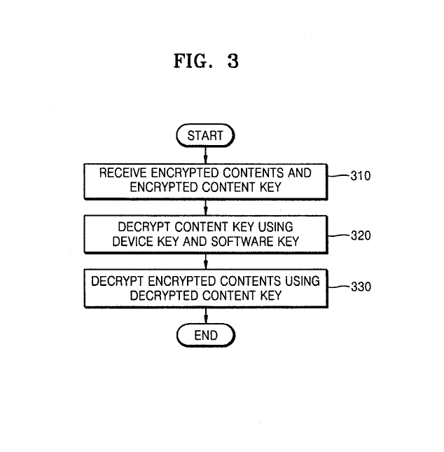

FIG. 3 is a flowchart illustrating a method of decrypting contents according to an embodiment of the present invention.

Referring to FIG. 3, the method of decrypting contents according to the current embodiment of the present invention includes receiving encrypted contents and an encrypted content key according to the contents, decrypting the contents using a device key of a device which receives the encrypted contents and the content key and the software key of the software program which is permitted to decrypt the encrypted contents received, and decrypting the encrypted contents using the decrypted content key in operations 310, 320, and 330, respectively.

That is, a decryption operation for the contents is performed by content protection software and the contents are decrypted as in the decryption method that corresponds to the encryption method for the content key in an encryption process for the contents. In other words, the content key is decrypted by using both the device key and software key and the contents are decrypted using the decrypted content key.

More specifically, the contents to be played are firstly received in an encrypted form and the content key used to encrypt the contents is received in operation 310.

In order to decrypt and play the contents, the content key should be firstly decrypted. The content key is decrypted using both the device key of the device which receives the encrypted contents and the software key of the software executed to play the contents in operation 320.

When the content key is decrypted, the contents that are to be substantially played are finally decrypted using the decrypted content key in operation 330.

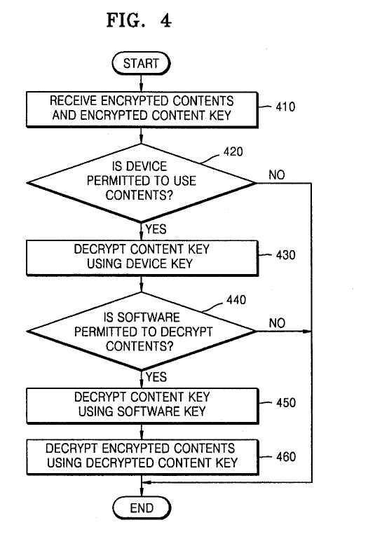

FIG. 4 is a flowchart illustrating a method of decrypting contents in more detail according to another embodiment of the present invention.

Referring to FIG. 4, the method of decrypting contents according to the current embodiment of the present invention is similar to that of FIG. 3; however, a two-step operation which is sequentially performed in decrypting the content key is described in more detail in the method of FIG. 4.

That is, after encrypted contents to be played and an encrypted content key are received in operation 410, it is determined whether a device which receives the encrypted content and the encrypted content key is permitted to use the content in operation 420. According to the determination result, if the device is permitted to use the content, the content key is firstly decrypted using a key of the device in operation 430. Then, it is determined in operation 440 whether the software is permitted to perform a decryption operation. Only when it is permitted to use the content, is the content key secondly decrypted using a software key in operation 450. Finally, the encrypted contents are decrypted using the content key generated due to decryption in operation 460.

In order to understand a conceptual flow of the decryption operation illustrated in FIG. 4, FIG. 8 can be referred to. FIG. 8 is a diagram for explaining an operation of an apparatus for decrypting contents, according to an embodiment of the present invention. Referring to FIG. 8, the apparatus includes a device 800-1 which receives an encrypted content key and contents and a software program 800-2 which substantially decrypts and plays the contents.

The encrypted content key is firstly decrypted using the device key in operation 810. The decrypted resultant is secondly decrypted using a software key in the software program 800-2. That is, decryption using the device key in operation 810 and decryption using the software key in operation 820 are sequentially performed. The contents are finally decrypted using the decrypted content key and the software program 800-2 of the device 800-1 can play the decrypted contents. Here, according to the order of applying the key in an encryption operation, the order of decryption can be also changed. In addition, a secret key or a private key can be used during decrypting according to an encryption method applied to an encryption operation. That is, when the secret key is used in an encryption operation, the secret key is also used in a decryption operation and the content key is decrypted (secret key-secret key). Also, when the public key is used in an encryption operation, the private key is used in a decryption operation and the content key is decrypted (public key-private key).

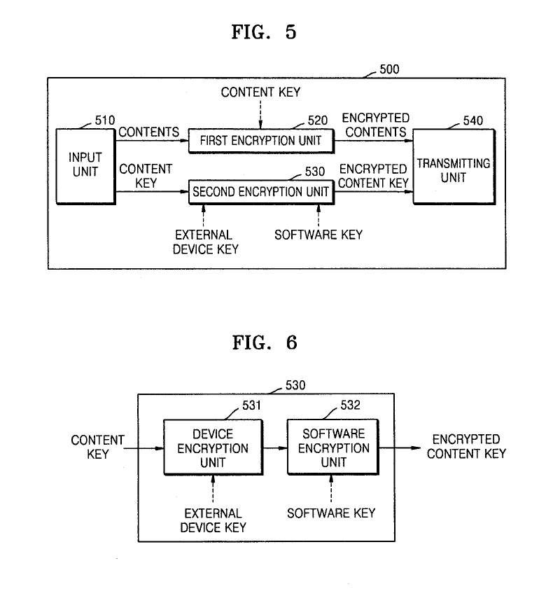

FIG. 5 is a functional block diagram of an apparatus 500 for encrypting and transmitting contents according to an embodiment of the present invention.

Referring to FIG. 5, the apparatus 500 for encrypting and transmitting contents according to the current embodiment of the present invention includes an input unit 510, first and second encryption units 520 and 530, and a transmitting unit 540. The functions of each element are as follows.

The input unit 510 receives contents to be transmitted. That is, data of the contents to which a contents protection system is applied is received and then is transmitted to the first and second encryption units 520 and 530.

The first encryption unit 520 encrypts the contents using a content key which is an encryption key according to the contents input to the input unit 510. Here, the content key which can be expressed as Kc is used as the encryption key.

The second encryption unit 530 receives the content key from the input unit 510 and encrypts the content key. Here, the content key is encrypted using an external device key of an external device which is permitted to receive and use the encrypted contents and a software key of a software program which is executed in the external device and permitted to decrypt the encrypted contents.

The transmitting unit 540 receives the encrypted contents and the content key to transmit to the external device.

FIG. 6 is a functional block diagram of the second encryption unit 530 of the apparatus 500 for encrypting and transmitting contents, according to an embodiment of the present invention.

Referring to FIG. 6, the second encryption unit 530 of FIG. 5 is illustrated in more detail. In FIG. 6, an encryption operation for the content key is illustrated, separately from encrypting the contents using the content key from the first encryption unit 520.

The second encryption unit 530 may further include internal encryption units such as a device encryption unit 531 and a software encryption unit 532. The device encryption unit 531 firstly encrypts the content key using the external device key and transmits the encrypted resultant to the software encryption unit 532. The software encryption unit 532 secondly encrypts the encrypted resultant received from the device encryption unit 531, using the permitted software key. As described above, the order of the encryption operation can be changed and the external device key and the software key can comprise a secret key or a public key.

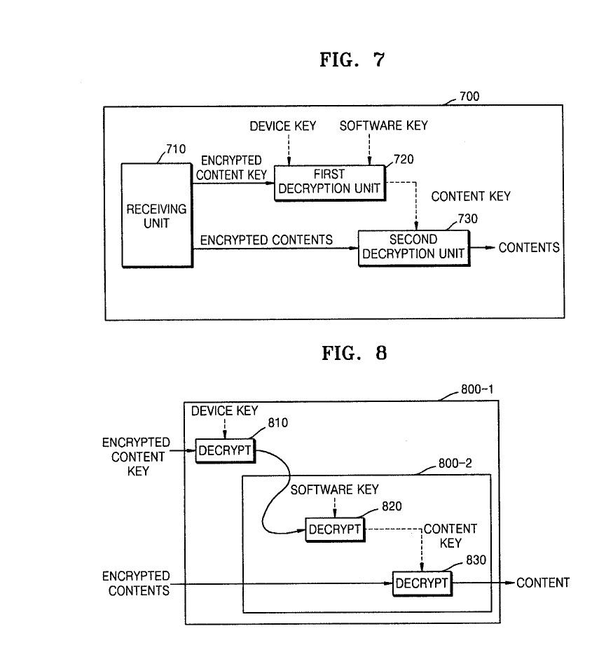

FIG. 7 is a functional block diagram of an apparatus 700 for decrypting contents according to an embodiment of the present invention.

The apparatus 700 for decrypting contents according to the current embodiment of the present invention includes a receiving unit 710 and first and second decryption units 720 and 730. The functions of each element are as follows.

The receiving unit 710 receives encrypted contents to be played and an encrypted content key for the encrypted contents and transmits the encrypted contents and the encrypted content key to the first and second decryption units 720 and 730.

The first decryption unit 720 decrypts the encrypted content key using a device key of a device which has embodied therein the apparatus 700 and receives the encrypted contents and the encrypted content key, and also using a software key of a software program which is permitted to decrypt the contents. In addition, the first decryption unit 720 may further include a software decryption unit (not illustrated) which decrypts the content key using the software key, and a device decryption unit (not illustrated) which decrypts again the content key decrypted in the software decryption unit using the device key. As a matter of fact, the order of the decryption operation between the software decryption unit and the device decryption unit can be changed mutually.

The second decryption unit 730 decrypts the encrypted contents using the decrypted content key obtained as the result in the first decryption unit 720.

FIG. 8 is a diagram for explaining an operation of an apparatus for decrypting contents, according to an embodiment of the present invention.

Referring to FIG. 8, the apparatus for decrypting contents according to the current embodiment of the present invention includes a device 800-1 which receives an encrypted content key and contents and a software program 800-2 which substantially decrypts and plays the contents.

In a decryption operation, decryption using a device key in operation 810 and decryption using a software key in operation 820 are sequentially performed. That is, the encrypted content key is firstly decrypted by using the device key in operation 810 and the decrypted resultant is secondly decrypted using the software key in the software program 800-2 in operation 820. The contents are finally decrypted using the decrypted content key in operation 830 and the software of the device can play, output and store the decrypted contents.

Here, according to the order of applying the key in an encryption operation, the order of decryption can be also changed. In addition, a secret key or a private key can be used during decrypting according to an encryption method applied to an encryption operation. That is, when a secret key is used in an encryption operation, the secret key is also used to decrypt the content key and when a public key is used in an encryption operation, the private key is used to decrypt the content key.

The method of encrypting/transmitting the contents and the method of decrypting the contents can be written as computer programs and can be implemented in general-use digital computers that execute the programs using a computer readable recording medium.

Also, a data structure used in the present invention can be written to a computer readable recording medium through various means.

Examples of the computer readable recording medium include magnetic storage media (e.g., ROM, floppy disks, hard disks, etc.) and optical recording media (e.g., CD-ROMs, or DVDs).

As described above, according to methods and apparatuses for encrypting and transmitting contents and decrypting the encrypted contents of the present invention, various content protection software is installed in one content device so that security for authority of use of the contents is improved in a content used environment. In particular, since security for the content key is improved, illegal distribution of the contents can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encrypting and transmitting contents, comprising:
encrypting contents to be transmitted using a content key which is an encryption key according to the received contents;
encrypting the content key using an external device key of an external device which is permitted to receive the encrypted contents to be used and a software key of a software program which is executed in the external device and permitted to decrypt the encrypted contents; and
transmitting the encrypted contents and the encrypted content key to the external device.

2. The method of claim 1, wherein the encrypting the content key comprises encrypting the content key using the external device key to generate an encrypted result and then encrypting the encrypted result using the software key.

3. The method of claim 1, wherein the encrypting the content key comprises encrypting the content key using the software key to generate an encrypted result and then encrypting the encrypted result using the external device key.

4. The method of claim 1, wherein the external device key and the software key comprise a secret key or a public key.

5. A method of decrypting encrypted contents, comprising:
receiving encrypted contents and an encrypted content key according to the received encrypted contents;
decrypting the encrypted content key using a device key of a device which receives the encrypted contents and the encrypted content key, and a software key of a software program which is permitted to decrypt the encrypted contents; and
decrypting the encrypted contents using the decrypted content key.

6. The method of claim 5, wherein the decrypting the encrypted content key comprises decrypting the encrypted content key using the device key to generate a decrypted result and then decrypting the decrypted result using the software key.

7. The method of claim 5, wherein the decrypting the encrypted content key comprises decrypting the encrypted content key using the software key to generate a decrypted result and then decrypting the decrypted result using the device key.

8. The method of claim 5, wherein the device key and the software key comprise a secret key or a private key.

9. An apparatus for encrypting and transmitting contents, comprising:
an input unit which receives contents to be transmitted;
a first encryption unit which encrypts the contents using a content key which is an encryption key according to the contents received by the input unit;
a second encryption unit which encrypts the content key using an external device key of an external device which is permitted to receive the encrypted contents to be used and a software key of a software program which is executed in the external device and permitted to decrypt the encrypted contents; and
a transmitting unit which transmits the encrypted contents and the encrypted content key to the external device.

10. The apparatus of claim 9, wherein the second encryption unit further comprises a device encryption unit which encrypts the content key using the external device key and a software encryption unit which encrypts the content key encrypted in the device encryption unit using the software key.

11. The apparatus of claim 9, wherein the second encryption unit further comprises a software encryption unit which encrypts the content key using the software key and a device encryption unit which encrypts the content key encrypted in the software encryption unit using the external device key.

12. The apparatus of claim 9, wherein the external device key and the software key in the second encryption unit comprise a secret key or a public key.

13. An apparatus for decrypting encrypted contents, comprising:
a receiving unit which receives encrypted contents and an encrypted content key according to the received encrypted contents;
a first decryption unit which decrypts the encrypted content key using a device key of a device which receives the encrypted contents and the encrypted content key, and a software key of a software program which is permitted to decrypt the encrypted contents; and
a second decryption unit which decrypts the encrypted contents using the content key decrypted in the first decryption unit.

14. The apparatus of claim 13, wherein the first decryption unit comprises a software decryption unit which decrypts the encrypted content key using the software key and a device decryption unit which decrypts the content key decrypted in the software decryption unit using the device key.

15. The apparatus of claim 13, wherein the first decryption unit comprises a device decryption unit which decrypts the encrypted content key using the device key and a software decryption unit which decrypts the content key decrypted in the device decryption unit using the software key.

16. The apparatus of claim 13, wherein the device key and the software key in the first decryption unit comprise a secret key or a private key.

17. A computer readable recording medium having embodied thereon a computer program for executing the method of claim 1.
